(19) United States
(12) Patent Application Publication
(10) Pub. No.: US 2026/0084555 A1
(43) Pub. Date: Mar. 26, 2026

(54) CHARGING DEVICE AND METHOD FOR OPERATING THE CHARGING DEVICE

(71) Applicant: Robert Bosch GmbH, Stuttgart (DE)

(72) Inventor: Lukas Wieditz, Achern (DE)

(21) Appl. No.: 19/112,628

(22) PCT Filed: Aug. 9, 2023
(86) PCT No.: PCT/EP2023/072034

§ 371 Date: Mar. 18, 2025

(30) Foreign Application Priority Data
Sep. 30, 2022 (DE) 10 2022 210 390.4

(51) Int. Cl. B60L 53/20; H02J 7/06; H02J 7/34; H02M 1/42; H02M 7/219

(52) U.S. Cl. CPC B60L 53/20; H02J 7/06; H02J 7/345; H02M 1/4233; H02M 7/219; B60L 2210/30; H02J 2207/20; H02J 2207/50

(57) ABSTRACT

Charging device for a vehicle, wherein the input side of the charging device (500) comprises an input terminal unit (100) for connecting a single-phase or multiphase alternating voltage and a PFC stage (200) for providing a direct voltage at an intermediate terminal (300), wherein the PFC stage (200) comprises a half-bridge (210, 220, 230) for each phase of the n-phases, wherein a first switching element (S1) is connected on one side to the positive ends of the half-bridges and on the other side to the positive intermediate terminal (310) and being designed to enable or interrupt a current flow between the positive ends of the half-bridges and the positive intermediate terminal (310) via the first switching element (S1).

### BACKGROUND

The invention relates to a charging device and a method for operating the charging device. Furthermore, the invention relates to a drive train with a charging device, a vehicle with a drive train as well as a computer program and a computer-readable storage medium.

Charging devices, for example in vehicles with an electric drive in an electric vehicle or a hybrid vehicle, are used to recharge batteries, preferably accumulators or traction batteries, from an electrical power source, preferably an external alternating voltage source or the public alternating voltage power supply. To this end, the charging device converts a sinusoidal alternating voltage current of the external power source to a direct voltage current. In a single-phase alternating voltage current, the power pulses at the double frequency of the alternating voltage current.

Preferably, charging devices have two-stage power electronics. A first stage, the so-called power-factor-correction stage, the PFC stage, converts the sinusoidal input voltage from the alternating voltage power grid into a direct voltage. A second stage consists of a direct voltage converter or DC/DC converter that ensures galvanic isolation via a transformer and adjusts the voltage levels. Preferably, the output voltage and/or the output current for charging the battery is adjusted by means of an electric circuit and a controller. An intermediate capacitor is arranged between the two stages, which buffers the power pulsation in the double frequency of the alternating voltage current of the power source. Typically, this intermediate circuit is realized by at least one electrolyte capacitor. These topologies allow for the maintenance of a near sinusoidal input current on the power grid side to meet power grid-side standards, a galvanic isolation between the power grid and vehicle to meet safety requirements, and a constant direct voltage output current on the side of the battery to minimize the load on the battery during charging.

In an electric drive vehicle, the battery is further connected to an inverter to supply energy to the electric drive machine. A direct voltage converter is connected in parallel to the inverter to supply a low-voltage network, or an on-board power supply, of the vehicle to supply the control units with energy. At the beginning of the charging process, the charging device is connected via the one PFC stage to the sinusoidal input voltage from the alternating voltage network or the AC low-voltage network. The PFC stage is connected or switched in on the output side to the intermediate capacitor, which is part of an intermediate voltage circuit. The intermediate voltage circuit is discharged when connected to the AC low-voltage network. Due to its low impedance, when the AC low-voltage network is switched on, a high input current results that charges the intermediate voltage circuit. In order to avoid power grid-side faults or the destruction of components of the power electronics, for example, fuses releasing due to excess current, this input current must be limited. One wide-spread implementation for input current limitation is the limitation via pre-charging resistors in the connecting lines between the alternating voltage power system and the PFC stage, which are bridged via relays during normal operation. A corresponding input current must be limited in each connecting line of the PFC stage. This requires a variety of pre-charging resistors and relays. Therefore, there is a need for a simple and compact solution that allows for charging of the intermediate capacitor with fewer components.

### SUMMARY

A charging device is provided for a vehicle, wherein the input side of the charging device comprises a single-phase or multiphase, n-phase input terminal unit, wherein n is a whole number greater than or equal to 1, preferably a three-phase input terminal unit, for connecting an n-phase alternating voltage and a PFC stage for providing a direct voltage at a bipolar intermediate terminal. The intermediate terminal includes a positive intermediate terminal and a negative intermediate terminal. The PFC stage includes an nth half-bridge per phase of the n-phases. A half-bridge each includes a series circuit with a high-side switch and a low-side switch. In each case, a center pickup between the high-side switch and the low-side switch of a half-bridge can be connected via an inductor to a one of the n input terminals of the n-phase input terminal unit via an nth connecting line in each case. Thus, for example, the center pickup of the first half-bridge can be connected to the first input terminal via the first inductor via the first connecting line. Thus, for example, the center pickup of the second half-bridge can be connected to the second input terminal via the second inductor via the second connecting line, etc. The n half-bridges are connected in parallel. The high-side switches are connected to the positive ends of the half-bridges and the low-side switches are connected to the negative ends of the half-bridges. The negative ends of the half-bridges are connected to the negative intermediate terminal. An intermediate capacitor is connected between the positive intermediate terminal and the negative intermediate terminal. This intermediate capacitor is part of the intermediate voltage circuit. A first switching element is connected to the positive ends of the half-bridges on one side and to the positive intermediate connection on the other side. The first switching element is configured to enable or interrupt current flow between the positive ends of the half-bridges and the positive intermediate terminal via the first switching element. Preferably, for a clearer representation, the convention is always used in the following sections that the first switching element is connected on one side to the positive ends of the half-bridges and on the other side to the positive intermediate terminal. Preferably, it is synonymous that the first switching element is connected on one side to the negative ends of the half-bridges and on the other side to the negative intermediate terminal. Preferably, this is already evident from the fact that the designation “positive” and “negative” is only used as a different designation and can be replaced with a list, such as “first” and “second”, which is equivalent in content.

Advantageously, a circuit for a charging device with a multiphase alternating voltage input is provided, where there is the possibility that an input current for charging the intermediate capacitor will flow through all phases of the alternating voltage input and through the PFC stage. By means of the first switching element, the input current following the half-bridges can be interrupted via the first switching element. Preferably, a pre-charging resistor is connected in parallel to the first switching element, which allows a limited charging current to charge the intermediate capacitor while bypassing the first switching element. Preferably, only after charging the intermediate capacitor is the first switching element opened and a low-impedance connection between the positive ends of the half-bridges and the positive intermediate connection is allowed. Advantageously, the otherwise necessary n pre-charging resistors, preferably each with a bridging switch element, are omitted between the individual input terminals and the inductors of the PFC stage. Preferably, the pre-charging resistor is a thermistor or PTC resistor used to limit the input current. Preferably, the input current for charging the intermediate capacitor from at least one of the input terminals flows into the intermediate capacitor via the PFC stage and the pre-charging resistor. The pre-charging resistor decreases the input current and thus prevents excess current. Preferably, to avoid losses in the pre-charging resistor, it is bridged by closing the first switching element when the intermediate capacitor is substantially charged.

An external power source is preferably a single-phase or multiphase, preferably a three-phase alternating voltage power system, preferably the low-voltage public power grid. Preferably, in a North American region or Japanese region, this is a 120 or 240 volt single-phase alternating voltage network. Preferably, in a Chinese or European region, this is a three phase alternating voltage power system of about 230 Volts. For charging operation of the charging device, the charging device is preferably connected to a corresponding alternating voltage power supply via the n-phase input terminal unit or connected to the corresponding alternating voltage. Preferably, the n-phase input terminal unit comprises a neutral terminal for connecting a neutral conductor of the alternating voltage power system to be connected. Preferably, a battery to be charged is an accumulator or a traction battery by means of which energy is supplied to an electric drive train of a vehicle. A rectification circuit is preferably a rectifier for converting the alternating voltage current into a direct voltage current. A high-side switch or a low-side switch of a semiconductor bridge is preferably a power semiconductor switch comprising an intrinsic diode, preferably an IGBT or MOSFET, preferably based on Si, SiC or GaN technology. Preferably, the expression connecting, for example, a center pickup to a connecting line, means contacting or connecting the components by means of an electrically conductive line or a galvanic connection. The expression blocking, preventing, decoupling or preventing a current flow means disconnecting an electrically conductive line or connection. Preferably, the expression switched is used synonymously with electrically connected, wherein switchably connected means that an electrical connection can be established or disconnected, preferably by means of a switch or switching element. Preferably, the expression arranged is used to define the position of an electrical component, preferably a switch or switching element, within the circuit topology, comprising an electrical connection to the adjacent electrical components.

In one embodiment, the first switching element is opened to charge the intermediate capacitor prior to the start of a charging operation, so that no charging current flows from the positive ends of the half-bridges via the first switching element to the positive intermediate connection.

Advantageously, controlling of the first switching element is provided, which prevents a current flow through the first switching element when charging the intermediate capacitor. As the current flows through the pre-charging resistor connected in parallel to the first switching element, no high input current or excessive current occurs through the phases of the input terminal.

In one embodiment, the intermediate capacitor is charged until the voltage at the intermediate capacitor corresponds to or exceeds a pre-determinable voltage value.

The opening of the first switching element for the charging operation of the intermediate capacitor is carried out until the voltage at the intermediate capacitor corresponds to or exceeds a pre-determinable voltage value. For this purpose, the voltage at the intermediate capacitor is determined by means of a detection unit or a measuring device and compared with the pre-determinable voltage value. This pre-determinable voltage value is pre-determined or corresponds to the voltage applied to at least one of the input terminals. To determine the pre-determinable value, preferably the voltage applied to one of the input terminals is determined by means of a suitable detection unit or measuring device, and preferably is determined as a voltage value as a function of the amount of the maximum amplitude. Alternatively, the voltage value is preferably pre-determined as a function of the connected alternating voltage or the region in which the charging device is operated, or preferably read and pre-determined from a characteristic diagram.

Alternatively, in another configuration, the intermediate capacitor is charged until the alternating voltage current through at least one of the connecting lines drops below a pre-determinable alternating voltage current value. Preferably, the specifiable alternating voltage current value is 100 mA. Preferably, the pre-determinable alternating voltage current value is provided as a minimum such that, when the first switching element is subsequently controlled such that a charging current is conducted from the positive ends of the half-bridges via the first switching element to the positive intermediate connection, no excess current occurs. Preferably, the alternating voltage current is determined for this purpose during charging of the intermediate capacitor by means of an alternating voltage current measuring device. The alternating voltage current measuring device is preferably arranged at least between one of the input terminals and the intermediate connection.

Advantageously, a controller is provided for the charging device that prevents a high input current through the phases of the input terminal to connect the multiphase alternating voltage.

In another configuration, to provide electrical energy at the intermediate terminal for a charging operation, an alternating voltage supplied to the input terminal unit via the PFC stage is provided at least in part as a direct voltage at the positive intermediate terminal and at the negative intermediate terminal, wherein the first switching element is closed, so that a charging current flows from the positive ends of the half-bridges via the first switching element to the positive intermediate terminal.

In a charging operation, the charging device converts the electrical power supplied to the input terminal unit, the alternating voltage supplied or the alternating voltage current supplied, into a charging voltage for charging a battery, preferably for charging a vehicle battery. The charging device is designed in two stages for this purpose. By means of the first stage, the PFC stage, the sinusoidal input voltage from the alternating voltage network is converted into a direct voltage in the intermediate voltage circuit. By means of the second stage, a downstream direct voltage converter, which preferably ensures galvanic isolation via a transformer, the voltage levels are adjusted and the charging voltage and the charging current for charging the battery are provided on the output side by means of a circuit and a controller.

Advantageously, a topology is provided that allows a direct voltage to be provided at the intermediate terminal for a charging process, wherein the power for this is provided by an external power source that provides a multiphase alternating voltage to the input terminal unit.

In another embodiment, the intermediate capacitor is configured as a series circuit consisting of a first capacitor and a second capacitor.

The intermediate capacitor is preferably configured as a series circuit consisting of a first and a second capacitor. Preferably, the capacitance of the first capacitor and the second capacitor is equal. Preferably, a neutral conductor, preferably switchable, is connected at a center pickup between the first and second capacitors for connecting to a corresponding contact of the input terminal unit. Preferably, a neutral conductor for operating the charging device is provided with asymmetric loading. Preferably, an asymmetric load is present in the case of operation with a 2-phase network or also with an asymmetric load in the case of operation with a 3-phase network, i.e., two-phase or three-phase alternating voltage. In these cases, a balancing current flows via the neutral conductor back into the alternating voltage power system connected on the input side.

Advantageously, a suitable circuit topology for connecting a neutral conductor is provided.

Furthermore, the invention relates to a drive train of a vehicle with a charging device as described above, wherein the drive train comprises in particular a traction battery, an inverter and/or an electric machine. Advantageously, a drive train of an electric vehicle is provided with a charging device having a simplified circuit topology.

The invention further relates to a vehicle having a drive train, as described above.

Advantageously, a vehicle having a charging device with a simplified circuit topology is provided.

The invention further relates to a method for operating a charging device as presented above with the step of: controlling the first switching element as well as the high-side and low-side switches of the half-bridges for supplying electrical energy at the intermediate capacitor.

By means of controlling the first switching element and the switch of the half-bridges, the alternating voltage applied to the input terminal is first used to charge the intermediate capacitor and then permanently converted into a direct voltage to supply the connected direct voltage converter of the charging device to generate the charging voltage for the battery to be charged. Advantageously, a method is provided that enables a direct voltage to be provided on the intermediate voltage circuit.

The invention further relates to a computer program comprising commands which, when the program is executed by a computer, prompt the latter to perform the method described.

The invention furthermore relates to a computer-readable memory medium comprising commands which, when executed by a computer, prompt the latter to perform the method steps described above.

It is understood that the features, properties, and advantages of the charging device apply or can be applied accordingly to the method or the drive train and the vehicle and vice versa.

Further features and advantages of embodiments of the invention are apparent from the following description with reference to the accompanying drawings.

### BRIEF DESCRIPTION OF THE DRAWINGS

The invention will be explained in further detail hereinafter with reference to the drawings:

FIG. 1 a schematic representation of a prior art embodiment of a circuit topology for a charging device

FIG. 2 a schematic illustration of an embodiment of a circuit topology for a charging device,

FIG. 3 a schematic illustration of a vehicle comprising a drivetrain with a charging device,

FIG. 4 a schematic illustration of a flow chart for a method for operating a charging device.

### DETAILED DESCRIPTION

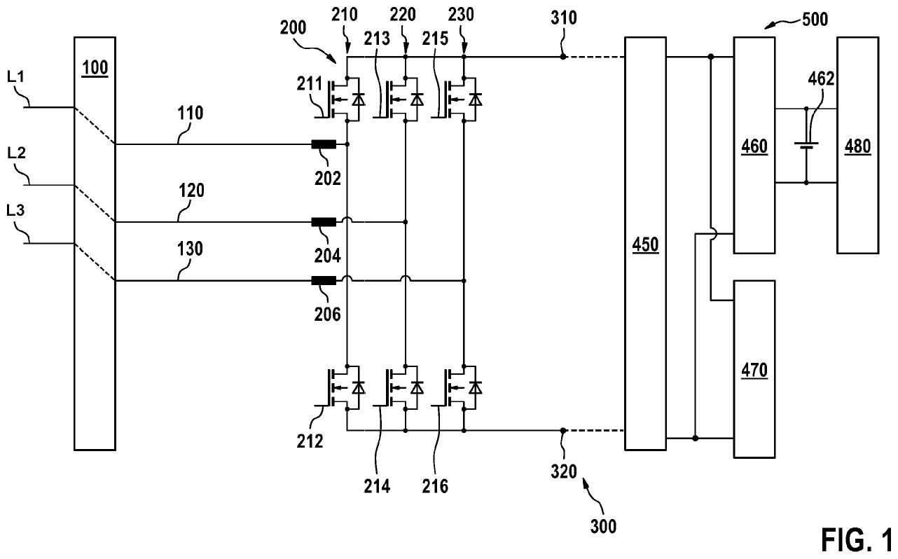

FIG. 1 shows a charging device 500, preferably for a vehicle. The charging device 500 comprises an input-side input terminal unit 100 for connecting a, for example, single-phase to three-phase alternating voltage and a PFC stage 200 for providing a direct voltage to an intermediate terminal 300. The PFC stage 200 of the charging device 500 includes a first 210, a second 220, and a third 230 half-bridge. The first, second, and third half-bridges 210, 220, 230 each include a series connection having a high-side switch 211, 213, 215 and a low-side switch 212, 214, 216. In each case, a center pickup between the high-side switch and the low-side switch of a half-bridge can be connected via a first, second and third inductor 202, 204, 206 to a first, second and third input terminal L1, L2, L3 of the input terminal unit 100 via a first, second and third connecting line 110, 120, 130 in each case. Thus, the center pickup of the first half-bridge 210 can be connected via the first inductor 202 to the first input terminal L1 via the first connecting line 110. Thus, the center pickup of the second half-bridge 220 can be connected via the second inductor 204 to the second input terminal L2 via the second connecting line 120. Thus, the center pickup of the third half-bridge 230 can be connected via the third inductor 206 to the third input terminal L3 via the third connecting line 130. The half-bridges 210, 220, 230 are connected in parallel. Their ends are connected to the bipolar intermediate terminal 300. The high-side switches are connected to a positive intermediate terminal 310 and the low-side switches are connected to a negative intermediate terminal 320. Preferably, a direct voltage converter 450 is connected to the intermediate terminal 300. The direct voltage at the intermediate terminal 300, which is applied to the input side of the direct voltage converter 450, is preferably converted into a charging voltage for charging a battery 470, preferably a traction battery or a high-voltage battery, which is connected to the output side of the direct voltage converter 450. Preferably, a further direct voltage converter 460, preferably a step-down converter, is connected in parallel with the battery 470 to convert the charging voltage into a low voltage for charging a low-voltage battery 462 and to supply an on-board power supply of a vehicle to supply control devices of a vehicle. The low-voltage battery 462, and preferably also further low-voltage loads 480, are connected to the vehicle's on-board power supply. Preferably, the further direct voltage converter 460 is a bidirectional direct voltage converter. Preferably, the further direct voltage converter 460 may be used to pre-charge the high-voltage intermediate circuit before the battery 470 is connected to the charging device 500. The high-voltage intermediate circuit is connected to the direct voltage converter 450 on the output side.

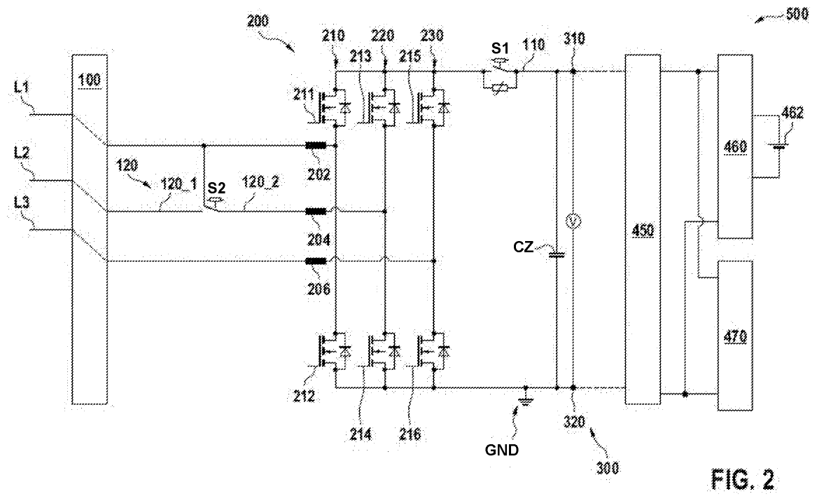

Starting from the charging device 500 according to FIG. 1, the charging device 500 according to FIG. 2 comprises a single-phase or multiphase, an n-phase input terminal unit 100 for connecting a multiphase alternating voltage with n-phases, wherein n is greater than or equal to 1. By way of example, a three-phase input terminal unit for connecting a single-phase to three-phase alternating voltage is shown. The n half-bridges 210, 220, 230 are connected in parallel. The high-side switches of the half-bridges are connected to the positive ends of the half-bridges and the low-side switches of the half-bridges are connected to the negative ends of the half-bridges. The negative ends of the half-bridges are connected to the negative intermediate terminal 320. A first switching element S1 is connected to the positive ends of the half-bridges on one side and to the positive intermediate connection 310 on the other side. It is configured to enable or interrupt current flow between the positive ends of the half-bridges and the positive intermediate terminal 310 via the first switching element S1. Preferably, the first switching element S1 is a pre-charging resistor, preferably a switchable resistor, a thermistor or NTC resistors, which are preferably connected in parallel so that a starting current or input current abates and is limited when an alternating voltage is connected to the input terminal unit 100 before the first switching elements S1 is closed. An intermediate capacitor CZ is connected in parallel to the half-bridges 210, 220, 230. An intermediate capacitor CZ is connected between the positive intermediate terminal 310 and the negative intermediate terminal 320. Preferably, the intermediate capacitor CZ is replaced by means of a series circuit consisting of a first C1 and a second C2 capacitor (not shown). Preferably, the second connecting line 120 is divided into a first part of the second connecting line 120_1 and a second part of the second connecting line 120_2. A second switching element S2 is preferably provided for this purpose, which is arranged between the first part of the second connecting line 120_1 and the second part of the second connecting line 120_2. Preferably, the second switching element S2 is configured to conduct a charging current from the second input terminal L2 via the first part and the second part of the second connecting line 120_1, 120_2 to the second inductor 204 or conduct a charging current from the first connecting line 110 via the second part of the second connecting line 120_2 to the second inductor 204. Preferably, the second switching element S2 is configured as a converter to implement this function. Preferably, due to the configuration of the second switching element as a second converter, a short circuit between the first connecting line and the first part of the second connecting line is prevented. Preferably, a short circuit between the first input terminal and the second input terminal would be possible by means of a faultily operated simple switching element. By means of the second converter, this error case can be reliably ruled out when it is controlled. Preferably, a switching element corresponding to the second switching element and its arrangement are also installed in further phases in addition to the first and the second phases of a PFC stage. Advantageously, preferably when connecting a single-phase external power source, the charging current is distributed over a plurality of phases by means of the second and further switching elements in order to load the individual components of the PFC stage more evenly. Preferably, a current sensor is arranged in series with each of the inductors to determine the current through the respective inductors 202, 204, 206 (not shown). Depending on the determined currents, preferably the high-side switches and the low-side switches as well as the switching elements are controlled to implement the desired operation modes. Preferably, a voltage sensor (V) is arranged between the positive and negative intermediate terminals 310, 320 to determine or measure the voltage at the intermediate capacitor. Depending on the determined voltages, preferably the high-side switch and the low-side switch as well as the switching elements are controlled to implement the desired operation modes. Preferably, the negative intermediate terminal 320 is connected to ground GND. Preferably, GND is an internal voltage potential. Preferably, the voltage at the intermediate capacitor is measured or determined between the positive intermediate terminal 310 and the negative intermediate terminal 320. Preferably, the voltage at the input terminal is measured and determined versus a neutral terminal (not shown). Preferably, the switching elements are provided as semiconductor switch components (IGBT or MOSFETS, based on Si, SiC or GaN) or as contactors or relays.

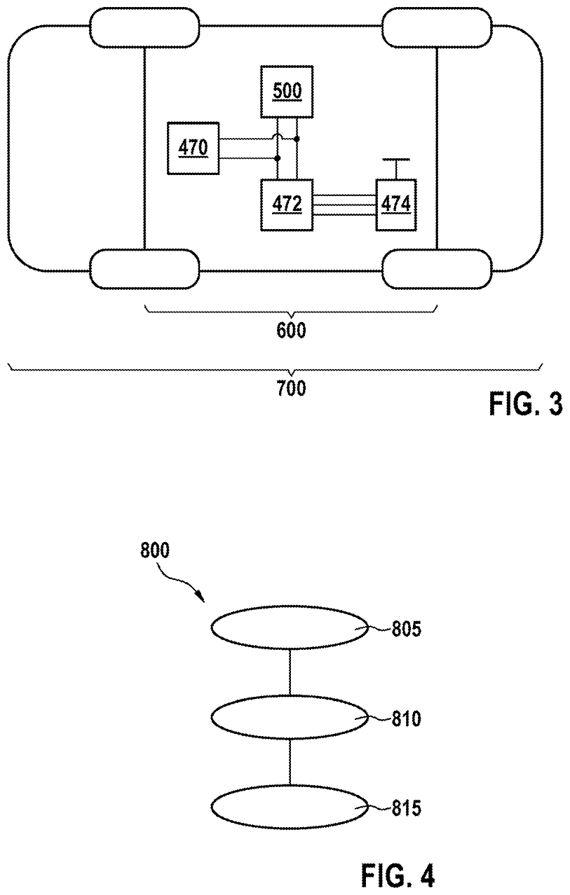

FIG. 3 shows a schematic illustration of a vehicle 700 comprising a drive train 600 with a charging device 500. The vehicle 700 is in this case shown (only by way of example) as comprising four wheels, wherein the invention can be used equally in any vehicle with any desired number of wheels on land, on water, and in the air. The exemplary powertrain 600 shown includes at least one charging device 500. Furthermore, the drive train preferably comprises a battery 470, an inverter 472 and/or or an electric machine 474.

FIG. 4 shows a schematic flow chart for a method 800 for operating a charging device 500. The method 800 starts with step 805. In step 810, the first switching element S1 as well as the high-side and low-side switches of the half-bridges 210, 220, 230 for supplying electrical energy to the intermediate capacitor CZ are controlled. The method ends at step 815.

1. A charging device for a vehicle,
wherein the input side of the charging device (500) comprises an input terminal unit (100) for connecting a single-phase or multiphase alternating voltage with n-phases, wherein n is greater than or equal to 1, and a PFC stage (200) for providing a direct voltage at an intermediate terminal (300),
wherein the PFC stage (200) comprises a half-bridge (210, 220, 230) for each phase of the n-phases,
wherein each half-bridge (210, 220, 230) is connected in series to a high-side switch (211, 213, 215) and a low-side switch (212, 214, 216), wherein a pickup in the center between the high-side switch and the low-side switch of each half-bridge can be connected, via an inductor (202, 204, 206) to each of the n input terminals (L1, L2, L3) of the input terminal unit (100) through an nth connecting line (110, 120, 130), wherein the n-half-bridges (210, 220, 230) are connected in parallel and wherein the high-side switches are connected to the positive ends of the half-bridges and the low-side switches are connected to the negative ends of the half-bridges,
wherein the negative ends of the half-bridges are connected to the negative intermediate terminal (320),
wherein an intermediate capacitor (CZ) is connected between the positive intermediate terminal (310) and the negative intermediate terminal (320), and
wherein a first switching element (S1) is connected on one side to the positive ends of the half-bridges and on the other side to the positive intermediate terminal (310) that is designed to enable or interrupt a current flow between the positive ends of the half-bridges and the positive intermediate terminal (310) via the first switching element (S1).

2. The charging device according to claim 1,
wherein, to charge the intermediate capacitor (CZ), the first switching element (S1) is opened prior to the start of a charging operation so that no charging current flows from the positive ends of the half-bridges via the first switching element (S1) to the positive intermediate connection (310).

3. The charging device according to claim 2,
wherein the intermediate capacitor (CZ) is charged until the voltage at the intermediate capacitor (CZ) exceeds a pre-determinable voltage value.

4. The charging device according to claim 1,
wherein an alternating voltage supplied to the input terminal unit (100) via the PFC stage (200) is provided at least in part as a direct voltage at the positive intermediate terminal (310) and the negative intermediate terminal (320), to provide electrical energy at the intermediate terminal (300) for a charging operation,
wherein the first switching element (S1) is closed so that a charging current flows from the positive ends of the half-bridges via the first switching element (S1) to the positive intermediate terminal (310).

5. The charging device according to claim 1, wherein the intermediate capacitor (CZ) is configured as a series circuit consisting of a first capacitor (C1) and a second capacitor (C2).

6. A drive train (600) of a vehicle (700) having a charging device (500) according to claim 1, wherein the drive train (600) comprises a traction battery (470), an inverter (472), and/or an electric machine (474).

7. A vehicle (700) having a drive train (600) according to claim 6.

8. A method (800) for operating a charging device according to claim 1, with the following step:
controlling (810) the first switching element (S1) as well as the high-side and low-side switches of the half-bridges (210, 220, 230) for supplying electrical energy at the intermediate capacitor (CZ).

9. (canceled)

10. A non-transitory, computer-readable storage medium comprising instructions which, when executed by a computer, prompt the computer to control a charging device for a vehicle,
wherein the input side of the charging device (500) comprises an input terminal unit (100) for connecting a single-phase or multiphase alternating voltage with n-phases, wherein n is greater than or equal to 1, and a PFC stage (200) for providing a direct voltage at an intermediate terminal (300),
wherein the PFC stage (200) comprises a half-bridge (210, 220, 230) for each phase of the n-phases,
wherein each half-bridge (210, 220, 230) is connected in series to a high-side switch (211, 213, 215) and a low-side switch (212, 214, 216), wherein a pickup in the center between the high-side switch and the low-side switch of each half-bridge can be connected, via an inductor (202, 204, 206) to each of the n input terminals (L1, L2, L3) of the input terminal unit (100) through an nth connecting line (110, 120, 130),
wherein the n-half-bridges (210, 220, 230) are connected in parallel and wherein the high-side switches are connected to the positive ends of the half-bridges and the low-side switches are connected to the negative ends of the half-bridges,
wherein the negative ends of the half-bridges are connected to the negative intermediate terminal (320),
wherein an intermediate capacitor (CZ) is connected between the positive intermediate terminal (310) and the negative intermediate terminal (320), and
wherein a first switching element (S1) is connected on one side to the positive ends of the half-bridges and on the other side to the positive intermediate terminal (310) that is designed to enable or interrupt a current flow between the positive ends of the half-bridges and the positive intermediate terminal (310) via the first switching element (S1), by
controlling (810) the first switching element (S1) as well as the high-side and low-side switches of the half-bridges (210, 220, 230) for supplying electrical energy at the intermediate capacitor (CZ).
